(19) United States
(12) Patent Application Publication
(10) Pub. No.: US 2023/0183591 A1
(43) Pub. Date: Jun. 15, 2023

(54) LUBRICATING OIL COMPOSITION FOR INTERNAL COMBUSTION ENGINE

(71) Applicant: ENEOS CORPORATION, Tokyo (JP)

(72) Inventors: Kohei SASAKI, Hiroshima (JP); Hideo TSUNEOKA, Kanagawa (JP); Kotaro WADA, Tokyo (JP)

(73) Assignee: ENEOS CORPORATION, Tokyo (JP)

(21) Appl. No.: 17/845,285

(22) Filed: Jun. 21, 2022

(30) Foreign Application Priority Data
Jun. 25, 2021 (JP) 2021-105924

(51) Int. Cl. C10M 125/26; C10M 101/02; C10M 169/04

(52) U.S. Cl. CPC C10M 125/26; C10M 101/02; C10M 169/04; C10M 2201/102; C10M 2201/087; C10M 2207/003; C10N 2010/04

(57) ABSTRACT

A lubricating oil composition for an internal combustion engine includes: (A) a lubricating base oil including at least one mineral oil-based base oil and having a kinematic viscosity at 100° C. of from 2.0 mm²/s or more and 4.3 mm²/s or less, and (B) a calcium borate-containing metallic detergent in an mount of 500 mass ppm or more and less than 1500 mass ppm in terms of calcium, based on a total amount of the composition. The composition has an evaporation loss by NOACK method (250° C., 1 h) of from 10 mass % or more and 40 mass % or less, and the composition has a viscosity index of from 140 or more and 350 or less. The lubricating oil composition is provided, wherein even in the case of using a highly evaporative base oil to make the viscosity low, the friction characteristic of the lubricating oil composition can be kept low.

### TECHNICAL FIELD

The present invention relates to a lubricating oil composition for an internal combustion engine. The present invention relates specifically to a lubricating oil composition for an internal combustion engine such that even in the case of using a highly evaporative base oil so as to make the viscosity low, the friction characteristic can be kept low.

### RELATED ART

Internal combustion engines have been served as power sources for various transportation means for a long time since their invention. In recent years, the demand for fuel efficiency in internal combustion engines has been increasing. To meet this demand, lubricating oils for internal combustion engines are also required to exert high fuel efficiency.

Various studies have been conducted to improve fuel-saving performance of lubricating oils for internal combustion engines. For example, WO 2018/212340 discloses an internal combustion engine-use lubricating oil composition having a specific formulation and excellent fuel-saving performance.

### SUMMARY OF INVENTION

In some lubricating oil composition for an internal combustion engine of an automobile, a decrease in viscosity resistance has been sought by making the viscosity of lubricating oil low in order to improve fuel-saving performance. However, a highly evaporative base oil may be used to make the viscosity of oil low. In this case, due to an increase in inter-metal contact site, the friction characteristic of the lubricating oil composition cannot be kept low. Thus, there is a concern about an increase in vibration during vehicle traveling and deterioration of drive comfort as caused by the above. Consequently, even if a highly evaporative and low-viscosity base oil is used, engine oil is required in which the friction characteristic of the lubricating oil composition is kept low.

The present inventors have conducted intensive research to solve the above-mentioned problems, and have found that even in the case of using a highly evaporative base oil so as to make the viscosity low, addition of a calcium borate-containing metallic detergent makes it possible to keep low the friction characteristic of a lubricating oil composition. Then, the invention has been completed.

The invention is based on such findings and provided as follows.
<1> A lubricating oil composition for an internal combustion engine, having:
(A) a lubricating base oil including at least one mineral oil-based base oil and having a kinematic viscosity at 100° C. of from 2.0 mm²/s or more and 4.3 mm²/s or less, and
(B) a calcium borate-containing metallic detergent in an mount of 500 mass ppm or more and less than 1500 mass ppm in terms of calcium, based on a total amount of the composition, wherein
the composition has an evaporation loss by NOACK method (250° C., 1 h) of from 10 mass % or more and 40 mass % or less, and
the composition has a viscosity index of from 140 or more and 350 or less.
<2> The lubricating oil composition for an internal combustion engine according to <1>, further having (C) a viscosity index improver,
wherein a content of the viscosity index improver is 0.1 mass % or more and less than 15.0 mass %.
<3> The lubricating oil composition for an internal combustion engine according to <1> or <2>, further having (D) magnesium sulfonate in an amount of from 100 mass ppm or more and 1000 mass ppm or less in terms of magnesium, based on the total amount of the composition.
<4> The lubricating oil composition for an internal combustion engine according to <1> or <2>, wherein the composition has an evaporation loss by NOACK method (250° C., 1 h) of from 15 mass % or more and 40 mass % or less.
<5> The lubricating oil composition for an internal combustion engine according to <1> or <2>, further having (E) a molybdenum-based friction modifier in an amount of from 100 mass ppm or more and 1000 mass ppm or less in terms of molybdenum, based on the total amount of the composition.
<6> The lubricating oil composition for an internal combustion engine according to <1> or <2>, wherein the calcium borate-containing metallic detergent is calcium borate salicylate.
<7> The lubricating oil composition for an internal combustion engine according to <1> or <2>, wherein
the lubricating base oil (A) has a kinematic viscosity at 100° C. of from 2.5 mm²/s or more and 4.0 mm²/s or less, and the composition has an HTHS viscosity at 150° C. of 2.3 mPa·s or less.
<8> The lubricating oil composition for an internal combustion engine according to <3>, wherein the composition has an evaporation loss by NOACK method (250° C., 1 h) of from 15 mass % or more and 40 mass % or less.
<9> The lubricating oil composition for an internal combustion engine according to <3> or <4>, further having (E) a molybdenum-based friction modifier in an amount of from 100 mass ppm or more and 1000 mass ppm or less in terms of molybdenum, based on the total amount of the composition.
<10> The lubricating oil composition for an internal combustion engine according to <3> or <4>, wherein the calcium borate-containing metallic detergent is calcium borate salicylate.
<11> The lubricating oil composition for an internal combustion engine according to <5>, wherein the calcium borate-containing metallic detergent is calcium borate salicylate.
<12> The lubricating oil composition for an internal combustion engine according to <3> or <4>, wherein
the lubricating base oil (A) has a kinematic viscosity at 100° C. of from 2.5 mm²/s or more and 4.0 mm²/s or less, and
the composition has an HTHS viscosity at 150° C. of 2.3 mPa·s or less.
<13> The lubricating oil composition for an internal combustion engine according to <5> or <6>, wherein
the lubricating base oil (A) has a kinematic viscosity at 100° C. of from 2.5 mm²/s or more and 4.0 mm²/s or less, and
the composition has an HTHS viscosity at 150° C. of 2.3 mPa·s or less.

The invention provides a lubricating oil composition for an internal combustion engine such that even in the case of using a highly evaporative base oil so as to make the viscosity low, the friction characteristic of the lubricating oil composition can be kept low.

### DESCRIPTION OF EMBODIMENTS

### [A] Lubricating Base Oil

In a lubricating oil composition of the invention, mineral oil-based base oil may be used as a lubricating base oil.

Examples of the mineral oil-based base oil used in the lubricating oil composition of the invention include distillate oil obtained by atmospheric distillation of crude oil. Alternatively, it is possible to use a lubricating oil distillate obtained by further vacuum distillation of the distillate oil and by purifying the resulting distillate oil by various refining processes. The refining process can be a combination of, for instance, hydrogenation refining, solvent extraction, solvent dewaxing, hydrogenation dewaxing, sulfuric acid cleaning, and/or white clay treatment, if appropriate. These refining processes may be combined in an appropriate order to produce a lubricating base oil usable in the invention. It is also possible to use a mixture of several refined oils with different properties, as obtained by subjecting different crude oils or distillate oils to different combinations of refining processes.

The mineral oil-based base oil used in the lubricating oil composition of the invention should preferably be one that belongs to Group III base oils according to the API classification. The API Group III base oils are mineral oil-based base oils with a sulfur content of 0.03 mass % or less, a saturated content of 90 mass % or more, and a viscosity index of 120 or more. Several types of Group III base oils may be used, or only one type may be used.

The mineral oil-based base oil used in the lubricating oil composition of the invention may be one that belongs to Group II base oils according to the API classification. The API Group II base oils are mineral oil-based base oils with a sulfur content of 0.03 mass % or less, a saturated content of 90 mass % or more, and a viscosity index of 80 or more and less than 120. It is preferable to use a mixture of Group II and Group III base oils.

The lubricating oil composition of the invention may contain only a mineral oil-based base oil as a lubricating base oil or may optionally contain another lubricating base oil. Specifically, in the lubricating oil composition of the invention, the content of mineral oil-based base oil can be, for example, 50 mass % or more, 60 mass % or more, 70 mass % or more, 80 mass % or more, 90 mass % or more, 95 mass % or more, or 99 mass % or more based on the lubricating base oil.

In a lubricating oil composition of the invention, a synthetic base oil may be used as the lubricating base oil. Examples of the synthetic base oil include poly-α-olefin or a hydride thereof, an isobutene oligomer or a hydride thereof, isoparaffin, alkylbenzene, alkylnaphthalene, diester (e.g., di-tridecylglutarate, di-2-ethylhexyl adipate, diisodecyl adipate, di-tridecyl adipate, di-2-ethylhexyl sebacate), polyol ester (e.g., trimethylolpropane caprylate, trimethylolpropane pelargonate, pentaerythritol 2-ethylhexanoate, pentaerythritol pelargonate), polyoxyalkylene glycol, dialkyl diphenyl ether, polyphenyl ether, or a mixture thereof. Among them, poly-α-olefin is preferable. Examples of the poly-α-olefin typically include an oligomer or co-oligomer (e.g., a 1-octene oligomer, decene oligomer, ethylene-propylene oligomer) of C₂₋₃₂, preferably C₆₋₁₆α-olefin or a hydrogenated product thereof.

The kinematic viscosity of the lubricating base oil contained in the lubricating oil composition of the invention at 100° C. is from 2.0 mm²/s to 4.3 mm²/s. The kinematic viscosity of the lubricating base oil in the invention at 100° C. is preferably 2.5 mm²/s or more, more preferably 2.8 mm²/s or more, and still more preferably 3.0 mm²/s or more. In addition, the upper limit is preferably 4.0 mm²/s or less, more preferably 3.9 mm²/s or less, and still more preferably 3.8 mm²/s or less. The specific range is from 2.5 mm²/s to 4.0 mm²/s, preferably from 2.8 mm²/s to 3.9 mm²/s, and more preferably from 3.0 mm²/s to 3.8 mm²/s. Sufficient fuel-saving performance can be obtained when the kinematic viscosity of the lubricating base oil at 100° C. is 4.3 mm²/s or less. In addition, the kinematic viscosity of the lubricating base oil at 100° C. may be 2.0 mm²/s or more. This can ensure oil film formation at lubrication sites and reduce the evaporation loss of the lubricating oil composition.

The kinematic viscosity at 100° C. means the kinematic viscosity of all lubricating base oils mixed together, i.e., the kinematic viscosity of base oils as a whole. In other words, it does not mean the kinematic viscosity of one specific lubricating base oil when multiple base oils are included.

Note that as used herein, the wording “kinematic viscosity at 100° C.” means a kinematic viscosity at 100° C. as measured in accordance with ASTM D-445.

In the lubricating oil composition of the invention, the content of the lubricating oil base oil based on the total amount of the lubricating oil composition is, for example, from 50 mass % to 95 mass %, preferably from 60 mass % to 95 mass %, more preferably from 70% to 95 mass %, still more preferably from 80 mass % to 95 mass %, and most preferably from 85 mass % to 95 mass %.

### [B] Calcium Borate-Containing Metallic Detergent

The lubricating oil composition of the invention contains a calcium borate-containing metallic detergent as a metallic detergent. Examples of the calcium borate-containing metallic detergent include calcium borate salicylate, calcium borate sulfonate, or calcium borate phenate. Calcium borate salicylate is preferred.

Calcium borate salicylate is calcium salicylate that has been overbased with boric acid or borate. Examples of calcium salicylate include a compound represented by the following formula (1).

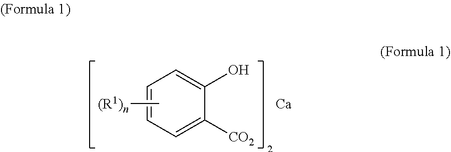

wherein R¹ each independently represents a C₁₄₋₃₀ alkyl group or an alkenyl group, and n represents 1 or 2. Ca represents calcium. Here, n is preferably 1. Note that when n=2, different R¹ groups may be used in combination.

Preferred examples of calcium sulfonate include a calcium salt of alkyl aromatic sulfonic acid as obtained by sulfonation of an alkyl aromatic compound. It is also possible to use a basic or overbased salt thereof. The alkyl aromatic compound has an weight average molecular weight of preferably from 300 to 1500 and more preferably from 400 to 700.

Examples of the alkyl aromatic sulfonic acid include what is called petroleum sulfonic acid or synthetic sulfonic acid. Examples of the petroleum sulfonic acid herein include a sulfonated alkyl aromatic compound in a lubricating oil distillate of mineral oil or so-called mahogany acid, a byproduct during white oil production. Also examples of the synthetic sulfonic acid include a sulfonated alkylbenzene having a linear or branched alkyl group, as obtained by recovering a byproduct in a detergent raw material alkylbenzene manufacturing plant, or by alkylating benzene with polyolefin. Another example of the synthetic sulfonic acid is sulfonated alkylnaphthalene such as sulfonated dinonylnaphthalene. The sulfonating agent used in the sulfonation of the alkyl aromatic compound is not particularly limited. For example, fuming sulfuric acid or anhydrous sulfuric acid can be used.

Calcium borate sulfonate is calcium sulfonate that has been overbased with boric acid or borate. Examples of calcium sulfonate include a compound represented by the following formula (2).

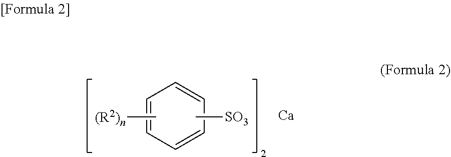

wherein R² each independently represents a C₁₀₋₈₀ alkyl group or an alkenyl group, and n represents 1 or 2. Ca represents calcium. Here, n is preferably 1. Note that when n=2, different R² groups may be used in combination. In the above formula (2), it is preferable to use calcium borate sulfonate that contains as a major component (e.g., 90 mol mass % or more based on total amount of sulfonate in calcium borate sulfonate) those in which R² each independently represents a C₁₀₋₄₀ alkyl or an alkenyl group.

Calcium borate phenate is calcium phenate that has been overbased with boric acid or borate. Examples of calcium phenate include a compound represented by the following formula (3).

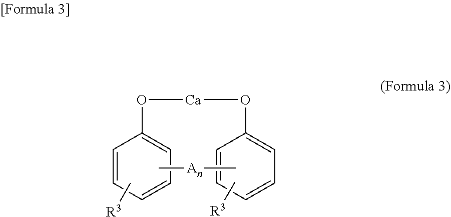

wherein R³ represents a C₆₋₂₁ linear or branched, saturated or unsaturated alkyl or an alkenyl group, and A represents a sulfide (—S—) group or a methylene (—CH2—) group, and n is an integer from 1 to 3. Note that two or more different R³ groups may be used in combination.

The number of carbon atoms of R³ in formula (3) is preferably from 9 to 18 and more preferably from 9 to 15. The solubility in base oil can be improved by setting the number of carbon atoms of R³ to be the lower limit or higher. In addition, if the number of carbon atoms of R³ is the upper limit or less, the production is easy.

The amount of calcium derived from the calcium borate-containing metallic detergent included in the lubricating oil composition of the invention is 500 mass ppm or more and less than 1500 mass ppm based on the total amount of the lubricating oil composition. The amount of calcium derived from the calcium borate-containing metallic detergent is preferably 700 mass ppm or more and more preferably 900 mass ppm or more. The upper limit is preferably 1450 mass ppm or less and more preferably 1400 mass ppm or less. The specific range is preferably from 700 mass ppm to 1450 mass ppm, and more preferably from 900 mass ppm to 1400 mass ppm. Calcium content derived from the calcium borate-containing metallic detergent may be set to be within the above range. This enables the friction characteristic of the lubricating oil composition to be kept low even in the case of using a highly evaporative base oil so as to make the viscosity low. As used herein, unless otherwise indicated, the content of each element such as calcium, magnesium, zinc, boron, phosphorus, or molybdenum in oil should be measured by inductively coupled plasma atomic emission spectrometry (intensity ratio method (internal standard method)) in accordance with JPI-5S-62.

The amount of boron derived from the calcium borate-containing metallic detergent contained in the lubricating oil composition of the invention is preferably 100 mass ppm or more, more preferably 200 mass ppm or more, more preferably 270 mass ppm or more, and most preferably 350 mass ppm or more, based on the total amount of the lubricating oil composition. The upper limit is preferably 800 mass ppm or less, more preferably 700 mass ppm or less, still more preferably 600 mass ppm or less, and most preferably 550 mass ppm or less. The specific range is preferably from 100 mass ppm to 800 mass ppm, more preferably from 200 mass ppm to 700 mass ppm, still more preferably from 300 mass ppm to 600 mass ppm, and most preferably from 350 mass ppm to 550 mass ppm.

### (Base Number of Calcium Borate-Containing Metallic Detergent)

The base number of the calcium borate-containing metallic detergent contained in the lubricating oil composition of the invention is preferably 140 mgKOH/g or more, more preferably 160 mgKOH/g or more, and still more preferably 180 mgKOH/g or more. The upper limit is preferably 500 mgKOH/g or less, more preferably 400 mgKOH/g or less, and still more preferably 300 mgKOH/g or less. The specific range is preferably from 140 mgKOH/g to 500 mgKOH/g, more preferably from 160 mgKOH/g to 400 mgKOH/g, and still more preferably from 180 mgKOH/g to 300 mgKOH/g. Note that the base number is measured according to the section 9 of JIS K 2501:2003.

### [D] Magnesium Sulfonate

The lubricating oil composition of the invention preferably further contains magnesium sulfonate as a metallic detergent.

Preferred examples of magnesium sulfonate include a magnesium salt of alkyl aromatic sulfonic acid as obtained by sulfonation of an alkyl aromatic compound. It is also possible to use a basic or overbased salt thereof. The alkyl aromatic compound has an weight average molecular weight of preferably from 300 to 1500 and more preferably from 400 to 700.

Examples of the alkyl aromatic sulfonic acid include what is called petroleum sulfonic acid or synthetic sulfonic acid. Examples of the petroleum sulfonic acid herein include a sulfonated alkyl aromatic compound in a lubricating oil distillate of mineral oil or so-called mahogany acid, a byproduct during white oil production. Also examples of the synthetic sulfonic acid include a sulfonated alkylbenzene having a linear or branched alkyl group, as obtained by recovering a byproduct in a detergent raw material alkylbenzene manufacturing plant, or by alkylating benzene with polyolefin. Another example of the synthetic sulfonic acid is sulfonated alkylnaphthalene such as sulfonated dinonylnaphthalene. The sulfonating agent used in the sulfonation of the alkyl aromatic compound is not particularly limited. For example, fuming sulfuric acid or anhydrous sulfuric acid can be used.

Examples of magnesium sulfonate include a compound represented by the following formula (4).

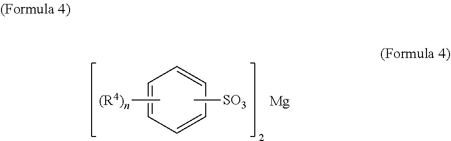

wherein R⁴ each independently represents a C₁₀₋₈₀ alkyl group or an alkenyl group, and n represents 1 or 2. Mg represents magnesium. Here, n is preferably 1. Note that when n=2, different R⁴ groups may be used in combination. Magnesium sulfonate may be overbased with carbonate or borate. In the above formula (4), it is preferable to use magnesium sulfonate that contains as a major component (e.g., 90 mol mass % or more based on total amount of sulfonate in magnesium sulfonate) those in which R⁴ each independently represents a C₁₀₋₄₀ alkyl or an alkenyl group.

The amount of magnesium derived from magnesium sulfonate contained in the lubricating oil composition of the invention is preferably 200 mass ppm or more and more preferably 300 mass ppm or more, based on the total amount of the lubricating oil composition. The upper limit is preferably 1000 mass ppm or less and more preferably 600 mass ppm or less. The specific range is preferably from 200 mass ppm to 1000 mass ppm, and more preferably from 300 mass ppm to 600 mass ppm.

### (Base Number)

The base number of the magnesium sulfonate contained in the lubricating oil composition of the invention is preferably 200 mgKOH/g or more, more preferably 250 mgKOH/g or more, and still more preferably 300 mgKOH/g or more. The upper limit is preferably 600 mgKOH/g or less, more preferably 500 mgKOH/g or less, and still more preferably 450 mgKOH/g or less. The specific range is preferably from 200 mgKOH/g to 600 mgKOH/g, more preferably from 250 mgKOH/g to 500 mgKOH/g, and still more preferably from 300 mgKOH/g to 450 mgKOH/g.

As long as the effects of the invention are not impaired, the lubricating oil composition of the invention can contain a metallic detergent other than the calcium borate-containing metallic detergent or magnesium sulfonate, such as a calcium-containing detergent that is not overbased with boric acid or borate.

The lubricating oil composition of the invention may contain a calcium-containing detergent that is not overbased with boric acid or borate. In this case, the amount of calcium derived from the detergent is preferably 900 mass ppm or less, more preferably 800 mass ppm or less, and still more preferably 700 mass ppm or less.

The total amount of calcium derived from the metallic detergent in the lubricating oil composition of the invention is preferably 400 mass ppm or more, more preferably 700 mass ppm or more, and still more preferably 1000 mass ppm or more, based on the total amount of the lubricating oil composition. The upper limit is preferably 1550 mass ppm or less, more preferably 1500 mass ppm or less, and still more preferably 1400 mass ppm or less. The specific range is preferably from 400 mass ppm to 1550 mass ppm, more preferably from 700 mass ppm to 1500 mass ppm, and still more preferably from 1000 mass ppm to 1400 mass ppm. If the total amount of calcium exceeds the above upper limit, the friction characteristic of the lubricating oil composition is not necessarily kept low.

### [C] Viscosity Index Improver

The lubricating oil composition of the invention preferably contains a viscosity index improver. It is possible to use, as the viscosity index improver, those commonly used in the field of a lubricating oil composition for an internal combustion engine. Specific examples include polymethacrylate, an olefin copolymer, polybutene, polyisobutene, polyisobutylene, polystyrene, an ethylene-propylene copolymer, or a styrene-diene copolymer, or a hydride thereof. Polymethacrylate is preferred.

The viscosity index improver contained in the lubricating oil composition of the invention has an weight average molecular weight of preferably 10,000 or more, more preferably 50,000 or more, and still more preferably 100,000 or more. The upper limit is preferably 1,000,000 or less, more preferably 800,000 or less, and still more preferably 600,000 or less. The specific range is preferably from 10,000 to 1,000,000, more preferably from 50,000 to 800,000, and still more preferably from 100,000 to 600,000.

The weight average molecular weight of high-molecular-weight polymer means a value determined by gel permeation chromatography (a molecular weight in terms of polystyrene)

The lubricating oil composition of the invention may contain a viscosity index improver. In this case, the content may be adjusted, if appropriate, so that the viscosity index of the lubricating oil composition is preferably from 140 to 350, more preferably from 150 to 300, and still more preferably from 180 to 290.

When the lubricating oil composition of the invention contains a viscosity index improver, the content based on the total amount of the lubricating oil composition is 0.1 mass % or more, preferably 1 mass % or more, more preferably 3 mass % or more, and still more preferably 4 mass % or more. The upper limit is 15 mass % or less, preferably 12 mass % or less, more preferably 10 mass % or less, and still more preferably 8 mass % or less. The specific range is from 0.1 mass % to 15 mass %, preferably from 1 mass % to 12 mass %, more preferably from 3 mass % to 10 mass %, and still more preferably from 4 mass % to 8 mass %.

### [E] Molybdenum-Based Friction Modifier

The lubricating oil composition of the invention preferably further contains a molybdenum-based friction modifier as a friction modifier. The molybdenum-based friction modifier is preferably molybdenum dithiocarbamate (hereinafter, simply referred to as MoDTC).

The MoDTC used may be, for example, a compound represented by the following formula (5).

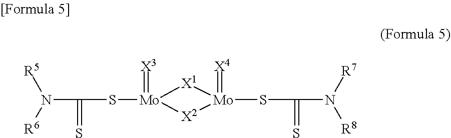

wherein R⁵ to R⁸ may be the same or different and are each a C₂₋₂₄ alkyl group or a C₆₋₂₄ (alkyl) aryl group, and preferably a C₄₋₁₃ alkyl group or a C₁₀₋₁₅ (alkyl) aryl group. The alkyl group may be any of a primary, secondary, or tertiary alkyl group, and may be linear or branched. Note that the “(alkyl)aryl group” means an “aryl group or an alkyl aryl group”. In the alkylaryl group, any of the substitution position of the alkyl group in the aromatic ring is allowed. X¹ to X⁴ are each independently a sulfur atom or an oxygen atom, and at least one of X¹ to X⁴ is a sulfur atom.

Examples of the molybdenum-based friction modifier other than MoDTC include molybdenum dithiophosphate, molybdenum oxide, molybdic acid, a molybdate (e.g., ammonium molybdate), molybdenum disulfide, sulfides of molybdic acid, or a sulfur-containing organic molybdenum compound.

The lubricating oil composition of the invention may contain a molybdenum-based friction modifier. In this case, the amount of molybdenum derived from the molybdenum-based friction modifier is preferably 100 mass ppm or more, more preferably 300 mass ppm or more, more preferably 500 mass ppm or more, and most preferably 700 mass ppm or more, based on the total amount of the lubricating oil composition. The upper limit is preferably 2000 mass ppm or less, more preferably 1000 mass ppm or less, and still more preferably 800 mass ppm or less. The specific range is preferably from 100 mass ppm to 2000 mass ppm, more preferably from 300 mass ppm to 1000 mass ppm, still more preferably from 500 mass ppm to 800 mass ppm, and most preferably from 700 mass ppm to 800 mass ppm. If the molybdenum content is the lower limit or more, fuel-saving performance can be enhanced. In addition, if the molybdenum content is the upper limit or less, the lubricating oil composition storage stability can be increased.

### (Additional Additive)

The lubricating oil composition of the invention may further contain an anti-wear agent, an antioxidant, and/or a dispersant.

Zinc dialkyl dithiophosphate (ZnDTP) is preferably added as the anti-wear agent. Examples of the zinc dialkyl dithiophosphate include a compound represented by the following formula (6).

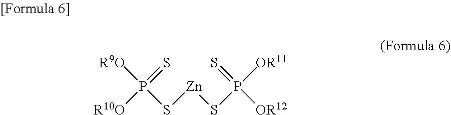

wherein R⁹ to R¹² are each independently a linear or branched C₁₋₂₄ alkyl group. This alkyl group may be primary, secondary, or tertiary. The dialkyl zinc dithiophosphate is preferably zinc dithiophosphate with a primary alkyl group (primary ZnDTP) or zinc dithiophosphate containing a secondary alkyl group (secondary ZnDTP). In particular, those primarily composed of zinc dithiophosphate containing a secondary alkyl group is preferable so as to increase wear resistance.

In the lubricating oil composition of the invention, one kind of the zinc dialkyl dithiophosphate may be used singly or two or more kinds thereof may be used in combination.

The amount of phosphorus derived from the zinc dialkyl dithiophosphate contained in the lubricating oil composition of the invention is preferably 100 mass ppm or, more preferably 500 mass ppm or more, and still more preferably 600 mass ppm or more, based on the total amount of the lubricating oil composition. The upper limit is preferably 2000 mass ppm or less, more preferably 1000 mass ppm or less, and still more preferably 800 mass ppm or less. The specific range is preferably from 100 mass ppm to 2000 mass ppm, more preferably from 500 mass ppm to 1000 mass ppm, and still more preferably from 600 mass ppm to 800 mass ppm.

The amount of zinc derived from the zinc dialkyl dithiophosphate contained in the lubricating oil composition of the invention is preferably 100 mass ppm or more, more preferably 500 mass ppm or more, and still more preferably 700 mass ppm or more, based on the total amount of the lubricating oil composition. The upper limit is preferably 2000 mass ppm or less, more preferably 1500 mass ppm or less, and still more preferably 1000 mass ppm or less. The specific range is preferably from 100 mass ppm to 2000 mass ppm, more preferably from 500 mass ppm to 1500 mass ppm, and still more preferably from 700 mass ppm to 1000 mass ppm.

It is possible to use, as the antioxidant, a known antioxidant such as a phenolic antioxidant or an amine-based antioxidant. Examples include an amine-based antioxidant (e.g., alkylated diphenylamine, phenyl-α-naphthylamine, alkylated-α-naphthylamine) or a phenolic antioxidant (e.g., 2,6-di-t-butyl-4-methylphenol, 4,4′-methylenebis (2,6-di-t-butyphenol)).

The lubricating oil composition may contain an antioxidant. In this case, the content is usually 5.0 mass % or less, preferably 3.0 mass % or less and preferably 0.1 mass % or more, and more preferably 0.5 mass % or more, based on the total amount of the lubricating oil composition.

Examples of the dispersant include an ashless dispersant such as succinimide or benzylamine.

The lubricating oil composition may contain a dispersant. In this case, the content is usually 5.0 mass % or less and preferably 0.1 mass % or more, based on the total amount of the lubricating oil composition.

To further improve the performance, the lubricating oil composition of the invention may contain an additional additive(s) commonly used in lubricating oils depending on the purpose. Examples of such an additive(s) include an additive(s) such as an anti-wear agent, an extreme pressure agent, a flow point depressant, a corrosion inhibitor, a rust inhibitor, a metal deactivator, and/or a defoaming agent.

### (Lubricating Oil Composition for an Internal Combustion Engine)

The HTHS viscosity of the lubricating oil composition of the invention at 150° C. is preferably from 1.7 mPa·s to 2.3 mPa·s, more preferably from 1.7 mPa·s to 2.2 mPa·s, and still more preferably from 1.7 mPa·s to 2.1 mPa·s. In the case of lower than 1.7 mPa·s, lubricity may be insufficient.

Note that the HTHS viscosity at 150° C. refers to a high-temperature high-shear viscosity at 150° C. as specified in ASTM D 4683.

The viscosity index for the lubricating oil composition of the invention is preferably from 140 to 350, more preferably from 150 to 300, and still more preferably from 180 to 290. If the viscosity index of the lubricating oil composition is 140 or more, the fuel-saving performance can be improved while the HTHS viscosity at 150° C. is kept low. In addition, if the viscosity index of the lubricating oil composition exceeds 350, evaporability may deteriorate.

Note that as used herein, the viscosity index means a viscosity index measured in accordance with JIS K 2283:2000.

The kinematic viscosity of the lubricating oil composition of the invention at 40° C. is preferably 10 mm²/s or more and more preferably 14 mm²/s or more. The upper limit is preferably 40 mm²/s or less, more preferably 35 mm²/s or less, and still more preferably 30 mm²/s or less. The specific range is preferably from 10 mm²/s to 40 mm²/s, more preferably from 14 mm²/s to 35 mm²/s, and still more preferably from 14 mm²/s to 30 mm²/s. Sufficient fuel-saving performance can be obtained when the kinematic viscosity of the lubricating oil composition at 40° C. is 40 mm²/s or less. In addition, the kinematic viscosity of the lubricating oil composition at 40° C. may be 10 mm²/s or more. This can ensure oil film formation at lubrication sites and reduce the evaporation loss of the lubricating oil composition.

Note that as used herein, the wording “kinematic viscosity at 40° C.” means a kinematic viscosity at 40° C. as measured in accordance with ASTM D-445.

The kinematic viscosity of the lubricating oil composition of the invention at 100° C. is preferably 3.0 mm²/s or more and more preferably 4.0 mm²/s or more. The upper limit is preferably 7.0 mm²/s or less and more preferably 6.0 mm²/s or less. The specific range is preferably from 3.0 mm²/s to 7.0 mm²/s, and more preferably from 4.0 mm²/s to 6.0 mm²/s. Sufficient fuel-saving performance can be obtained when the kinematic viscosity of the lubricating oil composition at 100° C. is 7.0 mm²/s or less. In addition, the kinematic viscosity of the lubricating oil composition at 100° C. may be 3.0 mm²/s or more. This can ensure oil film formation at lubrication sites and reduce the evaporation loss of the lubricating oil composition.

Note that as used herein, the wording “kinematic viscosity at 100° C.” means a kinematic viscosity at 100° C. as measured in accordance with ASTM D-445.

The density (ρ15) of the lubricating oil composition of the invention at 15° C. is preferably 0.860 g/cm³ or less and more preferably 0.850 g/cm³ or less. Note that as used herein, the “density at 15° C.” means a density at 15° C. as measured in accordance with ASTM D4052.

The lubricating oil composition of the invention has a NOACK evaporation loss at 250° C. of preferably from 10 mass % to 40 mass %, more preferably from 13 mass % to 40 mass %, still more preferably 15 mass % to 40 mass %, still more preferably from 20 mass % to 40 mass %, still more preferably from 22 mass % to 40 mass %, still more preferably from 25 mass % to 40 mass %, still more preferably from 27 mass % to 40 mass %, and most preferably from 30 mass % to 40 mass %. In the invention, the friction characteristic of the lubricating oil composition can be kept low even in the case of using a low-viscosity base oil, in which the NOACK evaporation loss in the lubricating oil composition is increased.

Note that as used herein, the “NOACK evaporation loss” or “evaporation loss by NOACK method” refers to the amount of evaporation of lubricating oil as measured in accordance with ASTM D 5800.

### EXAMPLES

Examples are used to describe the invention below. The invention, however, is not limited to the following disclosure. Unless otherwise indicated, the “%” indicates mass %.

### <Lubricating Oil Formulation>

In the respective Examples or Comparative Examples, base oils and additives were blended at each formulation ratio designated in Tables 1 to 2 to prepare each test lubricating oil composition. Each test lubricating oil composition obtained was evaluated as shown below.

Tables 1 to 2 show the evaluation results.

(A) Base oil

Base oil 1: Group III base oil (mineral oil), kinematic viscosity: 4.2 mm²/s (100° C.), viscosity index: 135

Base oil 2: Group II base oil (mineral oil), kinematic viscosity: 3.1 mm²/s (100° C.), viscosity index: 106

Each lubricating base oil was prepared by mixing base oils at each mass ratio designated in Tables 1 to 2. In the tables, the numbers of base oils each represent the mass ratio based on the total amount of base oils.

Additives were added as listed in Tables 1 to 2. The details of the additives were as follows. The amount of each additive blended is based on the total amount of the lubricating oil composition.

(B) Metallic detergent

Metallic detergent 1: calcium borate salicylate (calcium content: 6.8 mass %, boron content: 2.7 mass %, base number: 190 mgKOH/g)

Metallic detergent 2: calcium salicylate (calcium content: 8.0 mass %, base number: 225 mgKOH/g)

Metallic calcium 3: magnesium sulfonate (magnesium content: 9.1 mass %, base number: 405 mgKOH/g)

(C) Viscosity index improver

Viscosity index improver 1: polymethacrylate (weight average molecular weight: 520,000)

(D) Anti-wear agent

Anti-wear agent 1: zinc dialkyl dithiophosphate (zinc content: 9.3 mass %, phosphorus content: 8.5 mass %, sulfur content: 17.6 mass %; secondary ZnDTP)

(E) Friction modifier

Friction modifier 1: molybdenum dithiocarbamate (molybdenum content: 10.1 mass %, sulfur content: 10.8 mass %)

(F) Dispersant

Dispersant 1: alkenyl succinate polyalkylene polyimide (nitrogen content: 1.75 mass %)

(G) Antioxidant

Antioxidant 1: alkylated diphenylamine

Antioxidant 2: benzene propanoic acid,3,4-bis(1,1-dimethylethyl)-4-hydroxy-C7,C9 side chain alkyl ester

### <Evaluation Procedures>

(1) Friction characteristic

The friction characteristic of each test lubricating oil composition was tested. An MTM (Mini Traction Machine) tester (manufactured by PCS Instruments Inc.) was used to calculate, as a friction coefficient (μ), the friction characteristic of each lubricating oil composition at a constant load and a sliding rate. The test conditions are shown below. In this test, it is interpreted that as the friction coefficient becomes smaller, the friction characteristic is better. Note that the friction coefficient is a value obtained after 1-h sliding at a peripheral velocity of 250 mm/s.

Rolling speed: 200 mm/s

Load: 30 N

Sliding rate: 50%

Oil temperature: 100° C.

Tables 1 to 2 below show the results of evaluating each test lubricating oil composition. Note that the density of each test lubricating oil composition at 15° C. in Examples 1 to 4 or Comparative Examples 1 to 6 is all 0.850 g/cm³ or less.

TABLE 1

| | | | | | | | Comparative |
|---|---|---|---|---|---|---|---|
| | | | Example 1 | Example 2 | Example 3 | Example 4 | Example 1 |
| Base oil | Base oil 1 | mass % | 92 | 63 | 30 | — | 92 |
| | Base oil 2 | mass % | 8 | 37 | 70 | 100 | 8 |
| Metallic detergent | Metallic detergent 1 | mass % | 1.91 | 1.91 | 1.91 | 1.91 | — |
| | Metallic detergent 2 | mass % | — | — | — | — | 1.62 |
| | Metallic detergent 3 | mass % | 0.45 | 0.45 | 0.45 | 0.45 | 0.45 |
| Viscosity index | Viscosity index improver 1 | mass % | 3.8 | 4.8 | 6.0 | 7.5 | 3.8 |
| improver | | | | | | | |
| Anti-wear agent | Anti-wear agent 1 | mass % | 0.94 | 0.94 | 0.94 | 0.94 | 0.94 |
| Friction modifier | Friction modifier 1 | mass % | 0.80 | 0.80 | 0.80 | 0.80 | 0.80 |
| Dispersant | Dispersant 1 | mass % | 3.60 | 3.60 | 3.60 | 3.60 | 3.60 |
| Antioxidant | Antioxidant 1 | mass % | 0.50 | 0.50 | 0.50 | 0.50 | 0.50 |
| | Antioxidant 2 | mass % | 0.50 | 0.50 | 0.50 | 0.50 | 0.50 |
| Base oil properties | Kinematic viscosity (100° C.) | mm²/s | 4.11 | 3.79 | 3.43 | 3.10 | 4.11 |
| Composition | HTHS viscosity (100° C.) | mPa · s | 4.26 | 3.86 | 3.77 | 3.64 | 4.21 |
| characteristics | HTHS viscosity (150° C.) | mPa · s | 2.06 | 1.89 | 1.93 | 1.92 | 2.04 |
| | Viscosity index | | 181 | 184 | 235 | 279 | 181 |
| | Kinematic viscosity (40° C.) | mm²/s | 24.57 | 25.12 | 25.56 | 25.21 | 24.99 |
| | Kinematic viscosity (100° C.) | mm²/s | 5.035 | 5.121 | 5.172 | 5.134 | 5.70 |
| | NOACK evaporation loss | % | 13.4 | 20.9 | 28.4 | 35.8 | 13.3 |
| | (250° C., 1 h) | | | | | | |
| | B amount | massppm | 500 | 500 | 500 | 500 | Less than 1 |
| | Ca amount [Calculated value | massppm | 1300 | 1300 | 1300 | 1300 | 0 |
| | derived from Ca borate] | | | | | | |
| | Ca amount [Calculated value | massppm | — | — | — | — | 1200 |
| | derived from Ca salicylate] | | | | | | |
| | Mg amount | massppm | 430 | 430 | 430 | 430 | 430 |
| | Total Ca amount | massppm | 1300 | 1300 | 1300 | 1300 | 1200 |
| | Mo amount | massppm | 780 | 790 | 780 | 790 | 790 |
| | P amount | massppm | 790 | 800 | 800 | 800 | 800 |
| | Zn amount | massppm | 910 | 910 | 920 | 920 | 920 |
| Friction | 100° C. | | 0.031 | 0.031 | 0.033 | 0.031 | 0.034 |
| coefficient | | | | | | | |

TABLE 2

| | | | Comparative | Comparative | Comparative | Comparative | Comparative |
|---|---|---|---|---|---|---|---|
| | | | Example 2 | Example 3 | Example 4 | Example 5 | Example 6 |
| Base oil | Base oil 1 | mass % | 63 | 30 | — | 92 | 63 |
| | Base oil 2 | mass % | 37 | 70 | 100 | 8 | 37 |
| Metallic detergent | Metallic detergent 1 | mass % | — | — | — | 1.91 | 0.92 |
| | Metallic detergent 2 | mass % | 1.62 | 1.62 | 1.62 | — | 1.25 |
| | Metallic detergent 3 | mass % | 0.45 | 0.45 | 0.45 | 0.45 | 0.45 |
| Viscosity index | Viscosity index improver 1 | mass % | 4.8 | 6.0 | 7.5 | — | 0.38 |
| improver | | | | | | | |
| Anti-wear agent | Anti-wear agent 1 | mass % | 0.94 | 0.94 | 0.94 | 0.94 | 0.94 |
| Friction modifier | Friction modifier 1 | mass % | 0.80 | 0.80 | 0.80 | 0.80 | 0.80 |
| Dispersant | Dispersant 1 | mass % | 3.60 | 3.60 | 3.60 | 3.60 | 3.60 |
| Antioxidant | Antioxidant 1 | mass % | 0.50 | 0.50 | 0.50 | 0.50 | 0.50 |
| | Antioxidant 2 | mass % | 0.50 | 0.50 | 0.50 | 0.50 | 0.50 |
| Base oil properties | Kinematic viscosity (100° C.) | mm²/s | 3.79 | 3.43 | 3.10 | 4.11 | 3.79 |
| Composition | HTHS viscosity (100° C.) | mPa · s | 3.83 | 3.73 | 3.64 | 3.91 | 3.90 |
| characteristics | HTHS viscosity (150° C.) | mPa · s | 1.88 | 1.93 | 1.92 | 1.80 | 1.90 |
| | Viscosity index | | 184 | 235 | 279 | 131 | 181 |
| | Kinematic viscosity (40° C.) | mm²/s | 22.02 | 20.24 | 18.72 | 25.01 | 22.15 |
| | Kinematic viscosity (100° C.) | mm²/s | 5.25 | 5.51 | 5.65 | 5.04 | 5.23 |
| | NOACK evaporation loss | % | 21 | 29.9 | 36.7 | 14 | 21.1 |
| | (250° C., 1 h) | | | | | | |
| | B amount | massppm | Less than 1 | Less than 1 | Less than 1 | 500 | 250 |
| | Ca amount [Calculated value | massppm | 0 | 0 | 0 | 1300 | 630 |
| | derived from Ca borate] | | | | | | |
| | Ca amount [Calculated value | massppm | 1300 | 1200 | 1200 | 0 | 970 |
| | derived from Ca salicylate] | | | | | | |
| | Mg amount | massppm | 430 | 430 | 430 | 430 | 430 |
| | Total Ca amount | massppm | 1300 | 1200 | 1200 | 1300 | 1600 |
| | Mo amount | massppm | 790 | 800 | 780 | 800 | 800 |
| | P amount | massppm | 800 | 800 | 790 | 790 | 790 |
| | Zn amount | massppm | 910 | 920 | 950 | 910 | 910 |
| Friction | 100° C. | | 0.036 | 0.038 | 0.043 | 0.035 | 0.037 |
| coefficient | | | | | | | |

In Examples 1 to 4, the friction coefficient did not increase even as the value for the NOACK evaporation loss increased.

In Comparative Examples 1 to 4, the friction coefficient increased as the value for the NOACK evaporation loss increased.

The friction coefficient increased in Comparative Example 5 where the viscosity index was less than 140 or Comparative Example 6 where the total amount of calcium was 1600 mass ppm.

### INDUSTRIAL APPLICABILITY

The invention provides a lubricating oil composition for an internal combustion engine such that even in the case of using a highly evaporative base oil so as to make the viscosity low, the friction characteristic of the lubricating oil composition can be kept low.

1. A lubricating oil composition for an internal combustion engine, comprising:
(A) a lubricating base oil including at least one mineral oil-based base oil and having a kinematic viscosity at 100° C. of from 2.0 mm²/s or more and 4.3 mm²/s or less, and
(B) a calcium borate-containing metallic detergent in an mount of 500 mass ppm or more and less than 1500 mass ppm in terms of calcium, based on a total amount of the composition, wherein
the composition has an evaporation loss by NOACK method (250° C., 1 h) of from 10 mass % or more and 40 mass % or less, and
the composition has a viscosity index of from 140 or more and 350 or less.

2. The lubricating oil composition for an internal combustion engine according to claim 1, further comprising (C) a viscosity index improver,
wherein a content of the viscosity index improver is 0.1 mass % or more and less than 15.0 mass %.

3. The lubricating oil composition for an internal combustion engine according to claim 1 or 2, further comprising (D) magnesium sulfonate in an amount of from 100 mass ppm or more and 1000 mass ppm or less in terms of magnesium, based on the total amount of the composition.

4. The lubricating oil composition for an internal combustion engine according to claim 1 or 2, wherein the composition has an evaporation loss by NOACK method (250° C., 1 h) of from 15 mass % or more and 40 mass % or less.

5. The lubricating oil composition for an internal combustion engine according to claim 1 or 2, further comprising (E) a molybdenum-based friction modifier in an amount of from 100 mass ppm or more and 1000 mass ppm or less in terms of molybdenum, based on the total amount of the composition.

6. The lubricating oil composition for an internal combustion engine according to claim 1 or 2, wherein the calcium borate-containing metallic detergent is calcium borate salicylate.

7. The lubricating oil composition for an internal combustion engine according to claim 1 or 2, wherein
the lubricating base oil (A) has a kinematic viscosity at 100° C. of from 2.5 mm²/s or more and 4.0 mm²/s or less, and
the composition has an HTHS viscosity at 150° C. of 2.3 mPa·s or less.

8. The lubricating oil composition for an internal combustion engine according to claim 3, wherein the composition has an evaporation loss by NOACK method (250° C., 1 h) of from 15 mass % or more and 40 mass % or less.

9. The lubricating oil composition for an internal combustion engine according to claim 3, further comprising (E) a molybdenum-based friction modifier in an amount of from 100 mass ppm or more and 1000 mass ppm or less in terms of molybdenum, based on the total amount of the composition.

10. The lubricating oil composition for an internal combustion engine according to claim 3, wherein the calcium borate-containing metallic detergent is calcium borate salicylate.

11. The lubricating oil composition for an internal combustion engine according to claim 5, wherein the calcium borate-containing metallic detergent is calcium borate salicylate.

12. The lubricating oil composition for an internal combustion engine according to claim 3, wherein
the lubricating base oil (A) has a kinematic viscosity at 100° C. of from 2.5 mm²/s or more and 4.0 mm²/s or less, and
the composition has an HTHS viscosity at 150° C. of 2.3 mPa·s or less.

13. The lubricating oil composition for an internal combustion engine according to claim 5, wherein
the lubricating base oil (A) has a kinematic viscosity at 100° C. of from 2.5 mm²/s or more and 4.0 mm²/s or less, and
the composition has an HTHS viscosity at 150° C. of 2.3 mPa·s or less.

14. The lubricating oil composition for an internal combustion engine according to claim 4, further comprising (E) a molybdenum-based friction modifier in an amount of from 100 mass ppm or more and 1000 mass ppm or less in terms of molybdenum, based on the total amount of the composition.

15. The lubricating oil composition for an internal combustion engine according to claim 4, wherein the calcium borate-containing metallic detergent is calcium borate salicylate.

16. The lubricating oil composition for an internal combustion engine according to claim 4, wherein
the lubricating base oil (A) has a kinematic viscosity at 100° C. of from 2.5 mm²/s or more and 4.0 mm²/s or less, and
the composition has an HTHS viscosity at 150° C. of 2.3 mPa·s or less.

17. The lubricating oil composition for an internal combustion engine according to claim 6, wherein
the lubricating base oil (A) has a kinematic viscosity at 100° C. of from 2.5 mm²/s or more and 4.0 mm²/s or less, and
the composition has an HTHS viscosity at 150° C. of 2.3 mPa·s or less.
